(19) United States
(12) Patent Application Publication
(10) Pub. No.: US 2006/0128478 A1
(43) Pub. Date: Jun. 15, 2006

(54) Constant velocity joints

(75) Inventor: John Craven Carden, St. Clement, Jersey (GB)

Correspondence Address: SUGHRUE MION, PLLC, 2100 PENNSYLVANIA AVENUE, N.W., SUITE 800, WASHINGTON, DC, 20037, US

(73) Assignee: TRANSMISSION SYSTEMS LIMITED, JE2 QA, British Channel Islands (GB)

(21) Appl. No.: 10/519,916

(22) PCT Filed: Jul. 2, 2003
(86) PCT No.: PCT/GB03/02835

§ 371 Date: Aug. 10, 2005

(30) Foreign Application Priority Data
Jul. 4, 2002 (GB) 0215549.7

(51) Int. Cl. F16D 3/26

(52) U.S. Cl. 464/112

(57) ABSTRACT

The present invention relates to a constant velocity universal joint comprising two shafts (1, 2) each having a claw (3, 4) located on one end. First and second hinge elements (5, 6) are rotatably mounted between the claws (3, 4). A cage (7, 8) is also provided which can reciprocate with respect to the hinge elements (5, 6) in the direction of the hinge axis (H).

The present invention relates to constant velocity universal joints for use in any applications in which it is desired to transmit rotational movement between two rotary shafts which are inclined to one another at certain times. Such joints are typically used in the automotive industry, for example, in the drive shafts of front wheel drive vehicles.

The necessary relationships for true constant velocity are first, that the plane of contact between the two shafts must be held constant in space, secondly, that the plane of contact must be perpendicular to the plane determined by the rotational axis of the two shafts and, thirdly, that the plane of contact must define an angle with the axis of each shaft which is equal to one half of the total joint angle.

Reference should now be made to SAE Universal Joint and Drive Shaft Manual AE-7, Section 3.2.8 in which the Rzeppa universal joint is discussed. It may also be beneficial to refer to the Appendix H of the same publication.

The typical Rzeppa universal joint depicted in Figure A suffers from the disadvantage that the use of balls limits the degree of contact which is effectively “point” contact. Each of the six balls has one point of contact with the eccentric inner race or groove and one point of contact with the eccentric outer race or groove. Hence, the total area of contact is approximately 12×1 mm². In addition, the six balls are in sliding point contact rather than rolling contact so that the balls “skid” in order to move with the cage and satisfy the overriding requirement that the cage must deflect by one half of the joint angle.

The point contact and skidding of the balls results in a high surface pressure and high friction which causes heat generation and ultimately reduces the life of the joint. The problem of high surface pressure can be overcome in the present invention by increasing the area of contact between the moving parts which transmit torque.

Reference should also be made to International patent application WO 00/46522 which discloses various embodiments of a constant velocity joint in which the balls and eccentric outer and inner races of the Rzeppa universal joint have been replaced by hinge elements which can reciprocate within a cage. The central control mechanism described comprises the hinge elements the cage and guide elements which together ensure that the hinge axis always lies on the bisecting angle plane (constant velocity plane) between the two shaft axes. Accordingly, it will be appreciated that the movement of the plane of the balls in the Rzeppa universal joint must obey the same rule as the position of the hinge axis in WO 00/46522.

There are a number of disadvantages associated with the constant velocity joints disclosed in WO 00/46522. Reference should now be made to Figure B which has been taken from the published document WO 00/46522.

Clearly, the large number of parts required increases costs considerably. If possible, the number of parts should be minimised to reduce manufacturing costs and to facillitate assembly and disassembly if the joint fails for any reason.

It is apparent from WO 00/46522 that most of the torque is transmitted through the central pin 7b. The diameter of the pivot pin is typically 20 mm, and since there are two shear points, the cross-sectional area transmitting torque is approximately 2π r²=6.28 cm². This is low relative to the cross-sectional area for transmission of torque in the present invention.

It can also be seen that the torque arm is only half the length of the cylindrical eye of the drive pin 7a (i.e. typically 20 mm). Again, this figure is low compared to the torque arm in the present invention.

The total bearing surface area is also low. This area is the circumference of pivot pin 7b multiplied by its length of 3 cm (π×d×l) i.e. typically 18.85 cm². Again, the bearing surface area is dramatically increased in the present invention for a constant velocity joint with the same overall swing diameter.

Preferably, the distance travelled by the reciprocating mass, i.e. the cage, should be minimised. This mass multiplied by the distance travelled determines the imbalance load in the joint. In WO 00/146522 the distance travelled is typically 20 mm whereas in the present invention this figure can be reduced by approximately two thirds.

Clearly, in the present invention, it becomes relatively easy to have deflection angles as high as 60° with minor modifications to the configuration albeit with a somewhat reduced torque capacity for a given swing diameter.

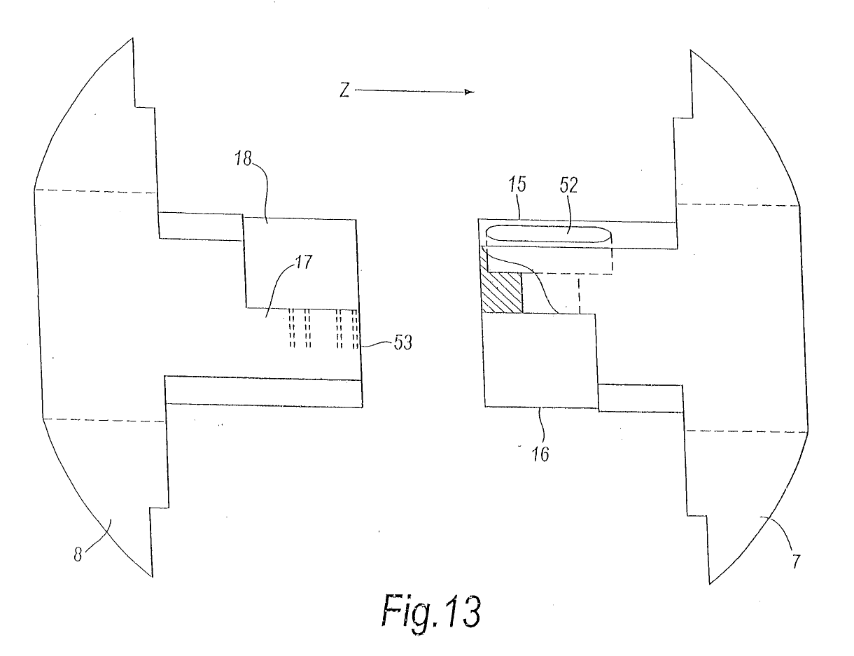

Finally, in WO 00/46522 there are only means for preloading the Timken assembly in the claw heads (see FIG. 13) but no means for preloading other portions of the joint. Therefore, backlash cannot be eliminated, which is obviously disadvantageous.

The problems associated with the constant velocity joints described above have been addressed in the present invention to achieve a more efficient, cost effective and long lasting joint, particularly at continuously high deflection angles. Most importantly, the constant velocity joint is approximately statically and dynamically balanced at all times.

According to the present invention, there is provided a constant velocity universal joint comprising two shafts, one shaft being the input and the other shaft being the output, each shaft having a claw located on one end, the claws being rotatably mounted on first and second hinge elements for rotation about an axis (V, V₁, V₂) which passes through the geometrical centre of the joint (G), and a cage which can reciprocate with respect to the hinge elements in the direction of the hinge axis (H), the cage containing the hinge elements and allowing them to oscillate relative to each other, the hinge axis (H) and the axis of each shaft intersecting at the geometrical centre (G) of the joint, characterised in that the claws have an eccentric cam profile which cooperates with the cage to produce the reciprocation of the cage with respect to the hinge elements whilst ensuring that the hinge axis (H) always lies on the bisecting angle plane between the two shaft axes.

Preferably, the claws rotate about the axis (V, V₁, V₂) by an equal and opposite amount relative to the hinge axis (H).

Preferably, centring control is provided by the cage, which ensures that three degrees of freedom of motion in two planes are accommodated.

Preferably, the cage performs two functions, the first being to hold the two hinge elements together to form the hinge and the second being to provide two face cams which react with the cam profile on the claws.

Preferably, the cage performs a third function in that it prevents any relative axial motion between the input and output shafts relative to the geometrical centre (G).

Preferably, the eccentric cam profile of each claw cooperates with the cage to produce reciprocation of the cage with respect to the hinge elements when the claws are rotated about the axis (V, V₁, V₂).

Preferably, the hinge elements each comprise a cross shaft with an integral stub axle which sits in a respective claw.

Preferably, each cross shaft is identical in form and has a part cylindrical groove and a pair of centre bearings are seated between the grooves, the cross shafts thereby pivoting on the centre bearings about hinge axis (H).

Preferably, the centre bearings prevent any relative axial motion between the cross shafts.

Preferably, each cross shaft is identical in form having a part cylindrical recess at one end and an integral centre bearing at the other end, the cross shafts pivoting with respect to each other about the hinge axis (H).

Preferably, the cage comprises two spaced containing rings fixedly connected to each other by projections which form cross beams between the containing rings and which extend parallel to the hinge axis (H).

Preferably, the containing rings can be axially preloaded against the cam profiles to reduce backlash.

Preferably, the motion of the containing rings over the surfaces of the cross shafts takes the form of a cylindrical ellipse thus ensuring lubricant flow motion.

Preferably, there is further provided a slipper element, which sits between the cooperating surfaces of a claw and the cage, to increase the surface area of contact.

Preferably, the slipper element can pivot about a point which passes through the centre of the cam profile of the claw.

Preferably, a tongue is provided on each slipper element which cooperates with an arcuate slot in a cross shaft to prevent tilting of the slipper element.

Preferably, each claw further comprises a preloading means to reduce backlash.

Preferably, the preloading means is a preloading plate to which the slipper element is pivotally connected.

Preferably, the first and second hinge elements are fixedly secured to the preloading plate on a respective claw such that the claws can rotate about the axis (V, V₁, V₂) with respect to the hinge elements and preloading plates.

Preferably, a centring mechanism is formed comprising the face cams on the cage, the slipper elements and the cam profile on each claw.

Preferably, the centring mechanism enables a secondary force, produced as a result of the torque passing through the joint when articulated in the plane at right angles to the axes of the cross shafts, to pass over the sliding external surfaces of the joint.

Preferably, the cage comprises two spaced containing rings fixedly connected to each other by a central cross beam which extends along and parallel to the hinge axis (H), the cross shafts pivoting with respect to each other about the central cross beam which also acts as the centre bearing.

Preferably, each cross shaft is identical in form and has a part cylindrical centrally located recess in which a cylindrical ring lock sits, the ring lock being slidable on the central cross beam whilst locking together the cross shafts to prevent any relative axial motion between the cross shafts and being free to rotate relative to the cross shafts.

Preferably, each containing ring is screw threaded onto one end of the central cross beam.

Preferably, there is further provided a slipper element which sits between the cooperating surfaces of a claw and the cage to increase the surface area of contact.

Preferably, the slipper element pivots about a point which passes through the centre of the cam profile of the claw.

Preferably, each claw further comprises preloading means to reduce backlash.

Preferably, the preloading means are crossed roller bearings located between the stub axle and the inside surface of the claw.

Preferably, the containing rings are preloaded against the slipper elements and the slipper elements are preloaded against the cam profiles by means of the screw threads between the containing rings and the central cross beam.

Preferably, the motion of the containing rings over the surfaces of the cross shafts takes the form of a cylindrical ellipse thus ensuring lubricant flow motion.

Preferably, the motion of the cross shafts over the surface of the central cross beam takes the form of a cylindrical ellipse thus ensuring lubricant flow motion.

Preferably, a centring mechanism is formed comprising the face cams on the cage, the slipper elements and the cam profile on each claw.

Preferably, the centring mechanism enables a secondary force, produced as a result of the torque passing through the joint when articulated in a plane at right angles to the axes of the cross shafts, to pass over the sliding external surfaces of the joint.

It is important to note that it is the movement of the eccentric cam profile of the claws against the cage which keeps the hinge axis on the bisecting angle plane between the two shalt axes.

It is also important to note that the entire joint rotates as a solid body and torque is transmitted from one shaft, via the claws cage and hinge elements to the other shaft. Since the contacting surfaces within the joint are large, torque is transmitted through a much greater surface area than in the prior art arrangements.

Preferred embodiments of the present invention will now be described, by ay of example only, with reference to the accompanying drawings, of which:

Figures A and B depict prior art constant velocity universal joints;

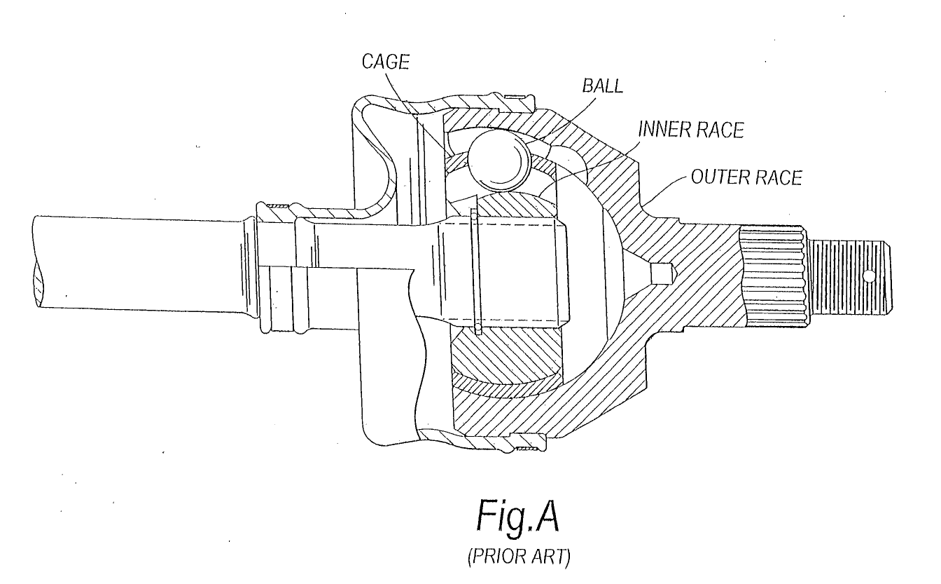

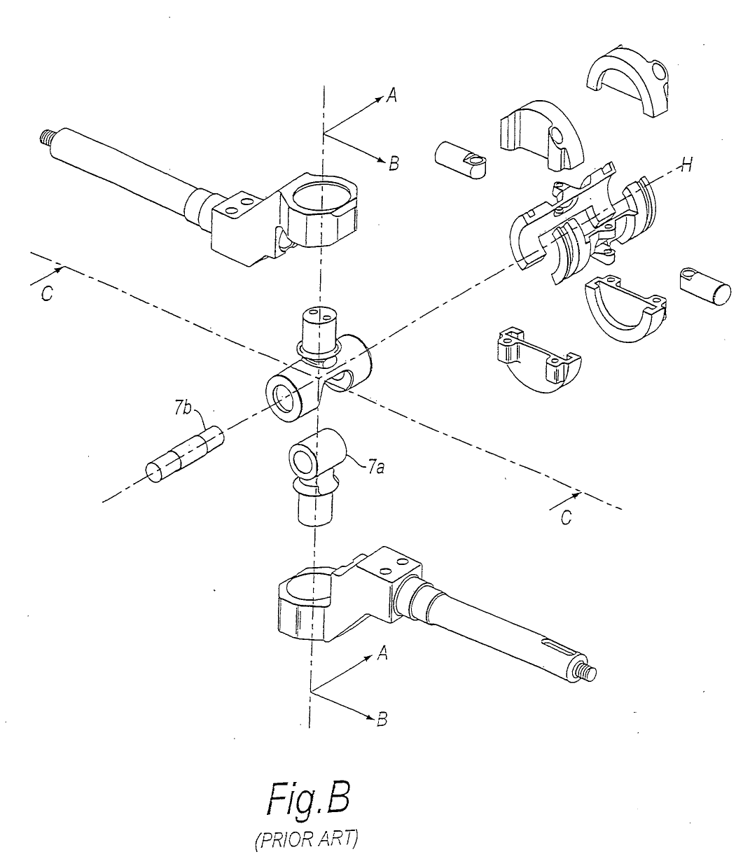

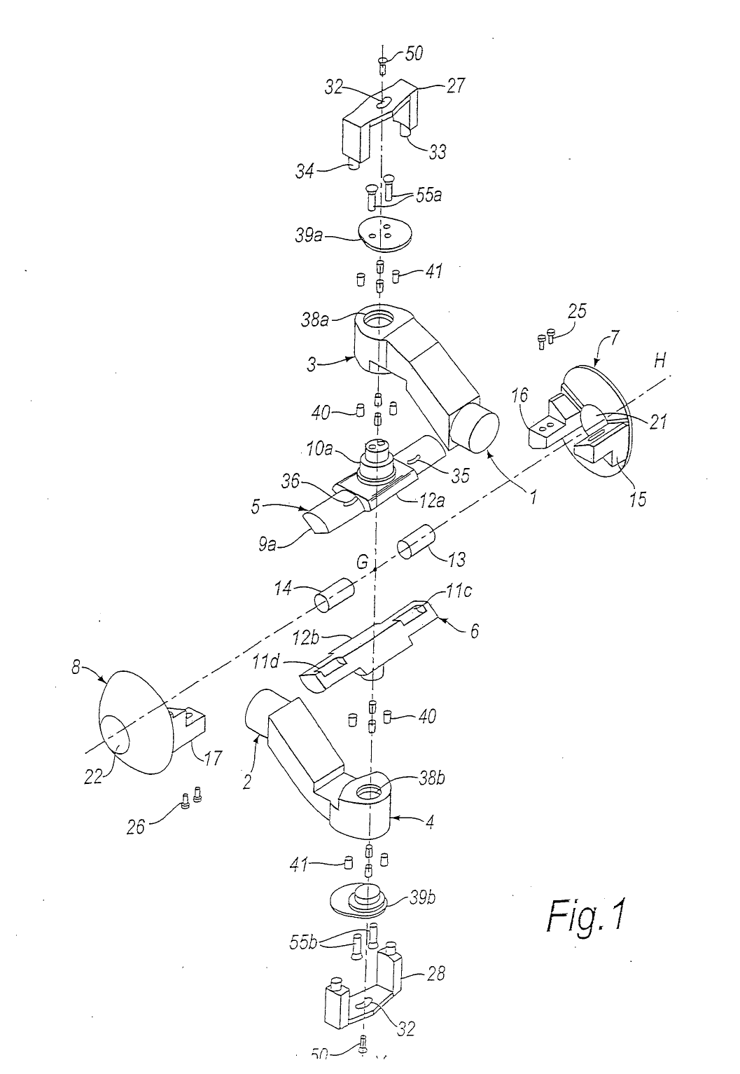

FIG. 1 is an exploded schematic view of the main elements of a constant velocity universal joint according to a first preferred embodiment of the present invention;

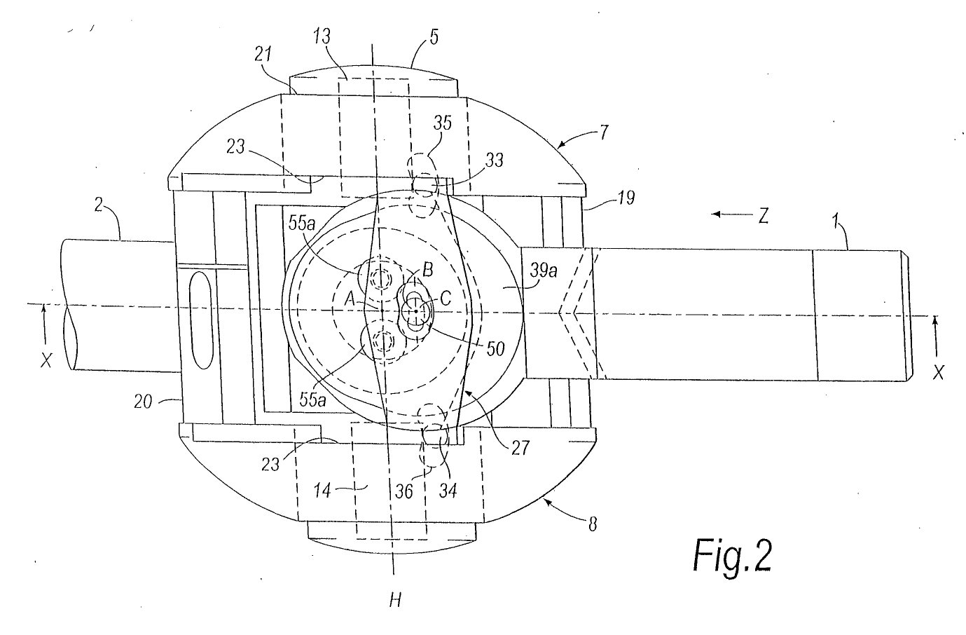

FIG. 2 is a view down the axis V of the joint in FIG. 1 when the shafts are aligned;

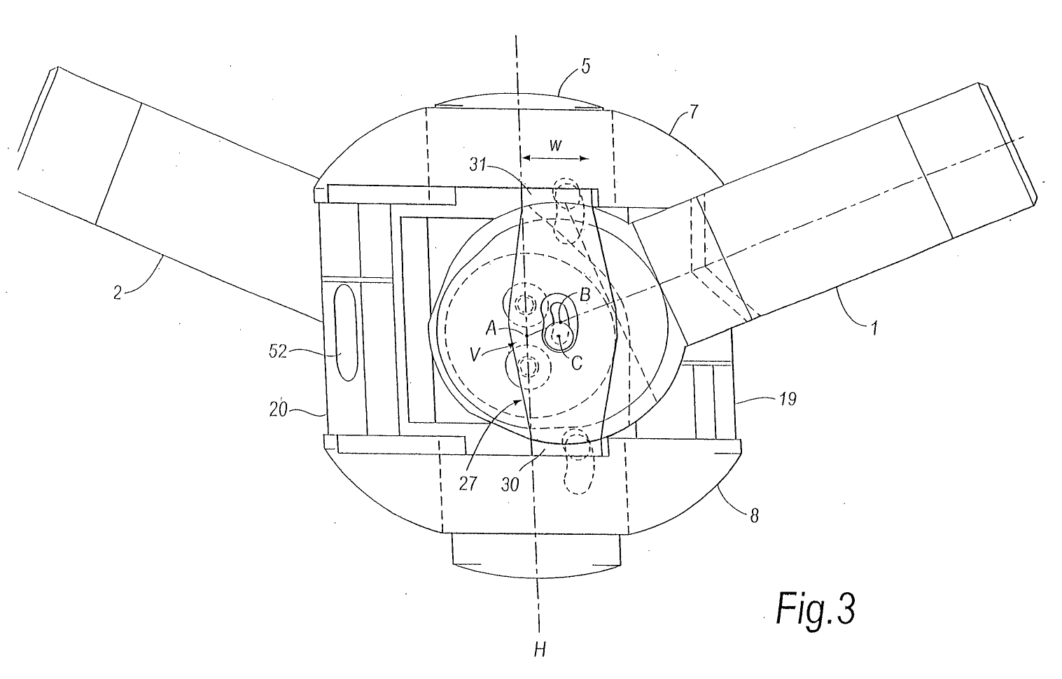

FIG. 3 is a view down the axis V when the shafts have been articulated by 22.5° from the aligned position;

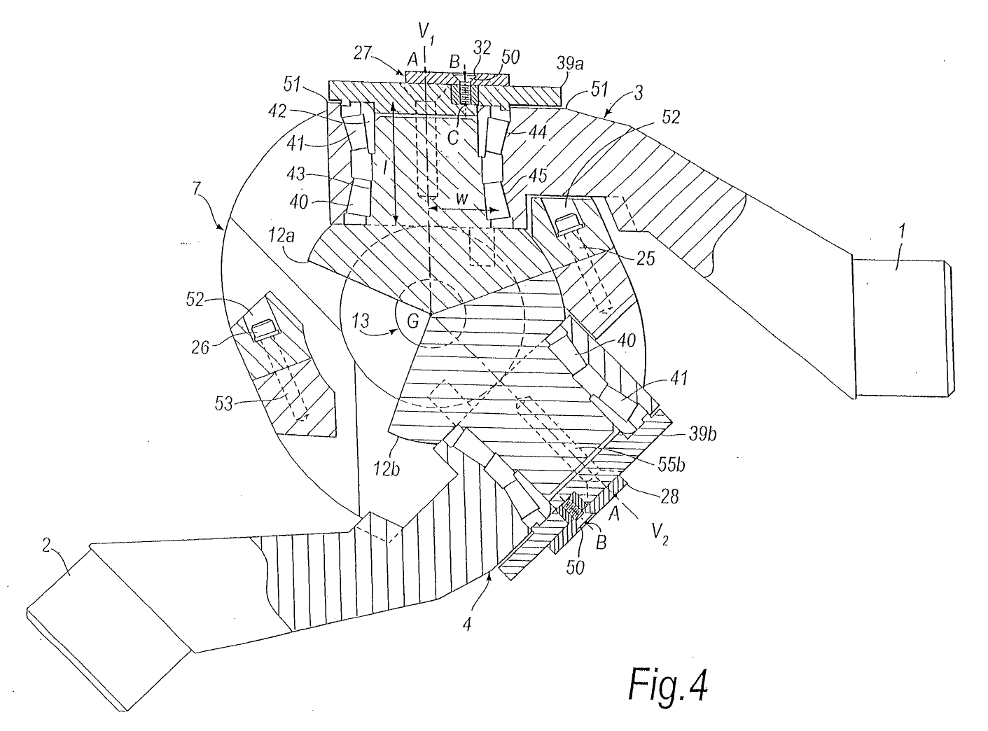

FIG. 4 is a central sectional view through FIG. 2 in direction X-X when the lower shaft has been articulated by 45° from the aligned position;

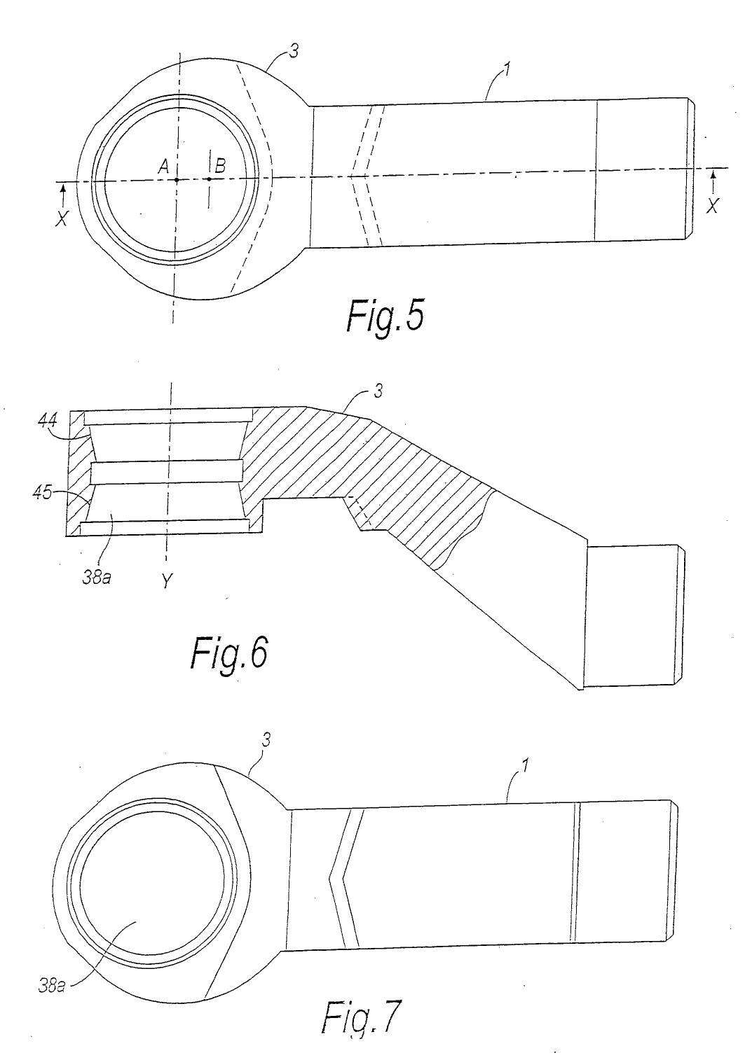

FIG. 5 is a view of just the upper shaft and claw in FIG. 2;

FIG. 6 is a central sectional view through FIG. 5 in direction X-X;

FIG. 7 is a view in direction Y in FIG. 6;

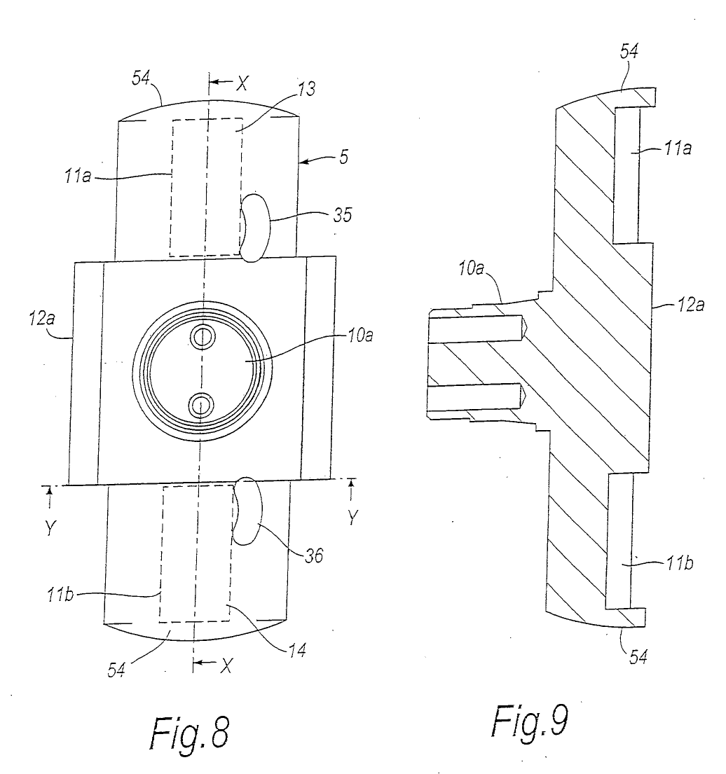

FIG. 8 is a view of just the upper cross shaft in FIG. 2;

FIG. 9 is a central sectional view through FIG. 8 in direction X-X;

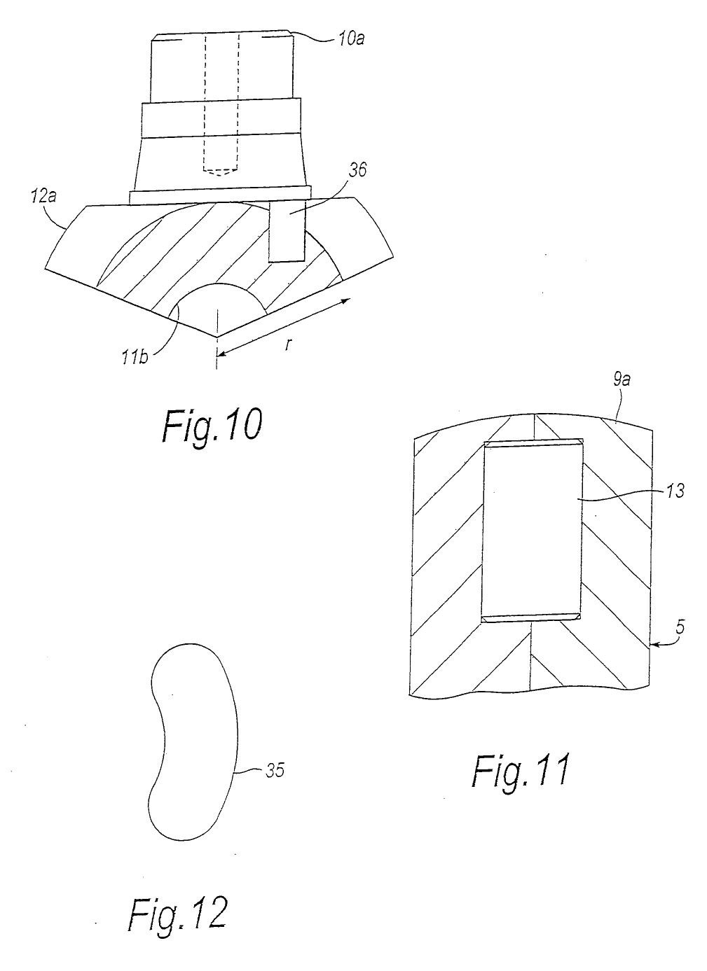

FIG. 10 is a cross-sectional view in direction Y-Y in FIG. 8;

FIG. 11 is a partial cross-sectional view of one of the centre bearings sitting in a cross-shaft;

FIG. 12 is a greatly enlarged view of one of the arcuate slots in the cross shaft in FIG. 8;

FIG. 13 is a side view in direction Z of just the containing rings in FIG. 2;

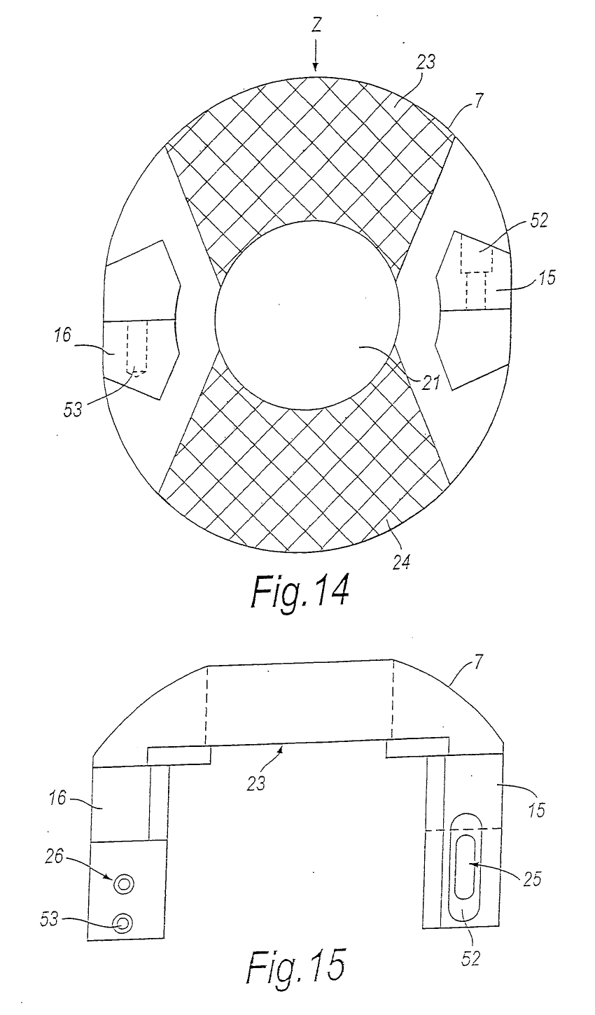

FIG. 14 is an end view in direction Z of one of the containing rings in FIG. 13;

FIG. 15 is a view from above in direction Z of the containing ring in FIG. 14;

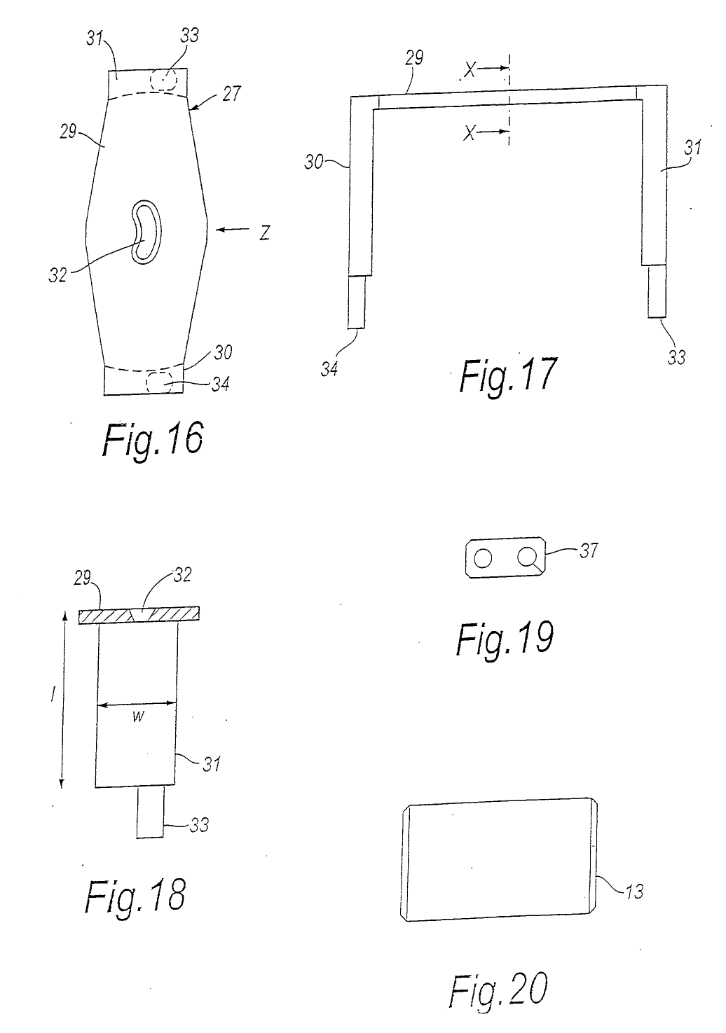

FIG. 16 is a view from above of just the slipper in FIG. 2;

FIG. 17 is a side view in direction Z of the slipper in FIG. 16;

FIG. 18 is a cross-sectional view in direction X-X of the slipper in FIG. 17;

FIG. 19 shows detail of one of the washers which sits in the connecting cross beams of the containing rings;

FIG. 20 shows detail of one of the central bearings which sits in the cross shafts.

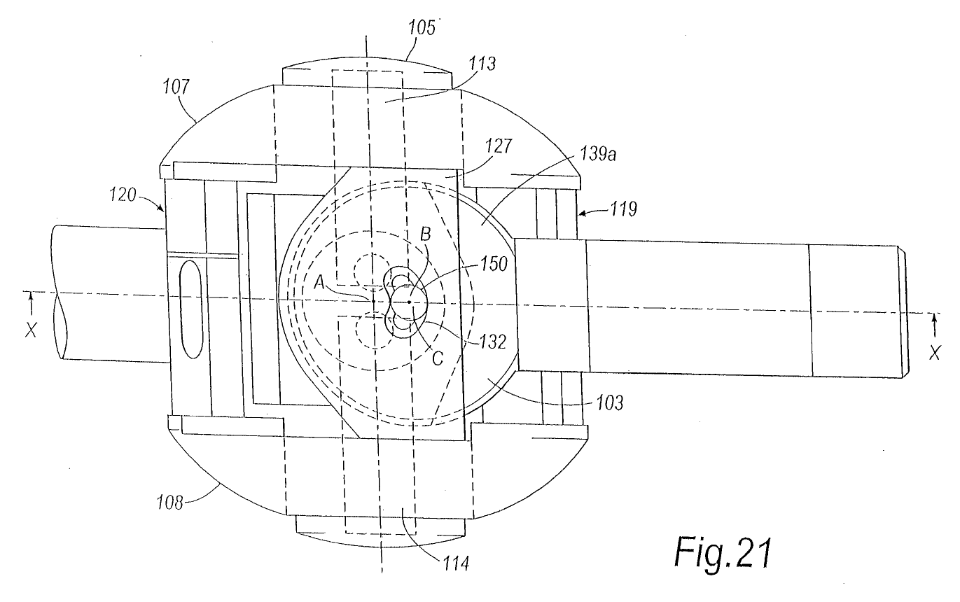

FIG. 21 is a view of a second preferred embodiment of the present invention down the axis V when the shafts are aligned;

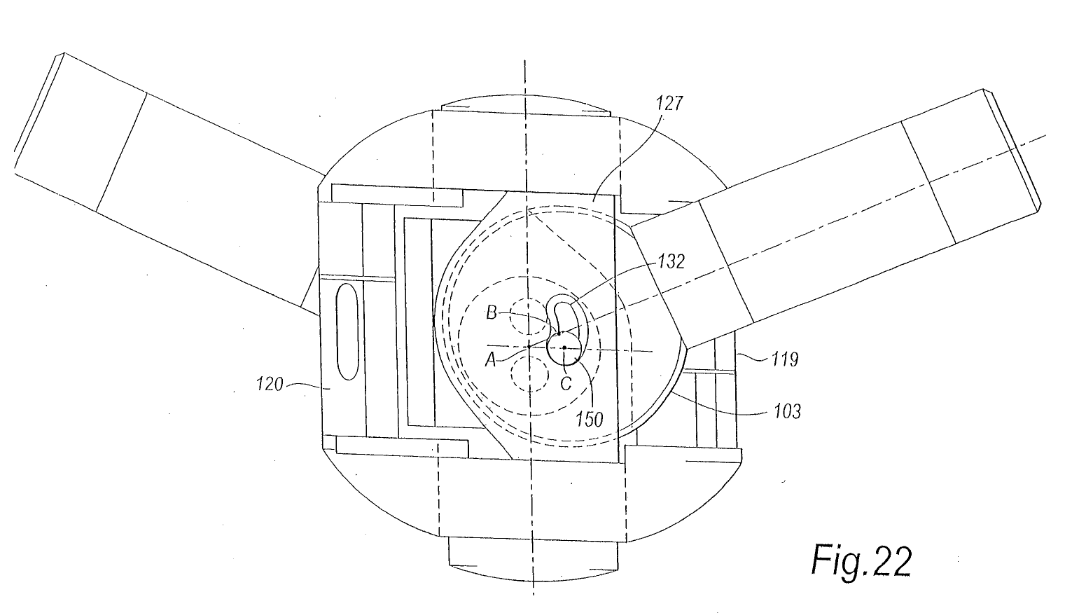

FIG. 22 is a view of the joint in FIG. 21 when the shafts have been articulated by 22.5° from the aligned position;

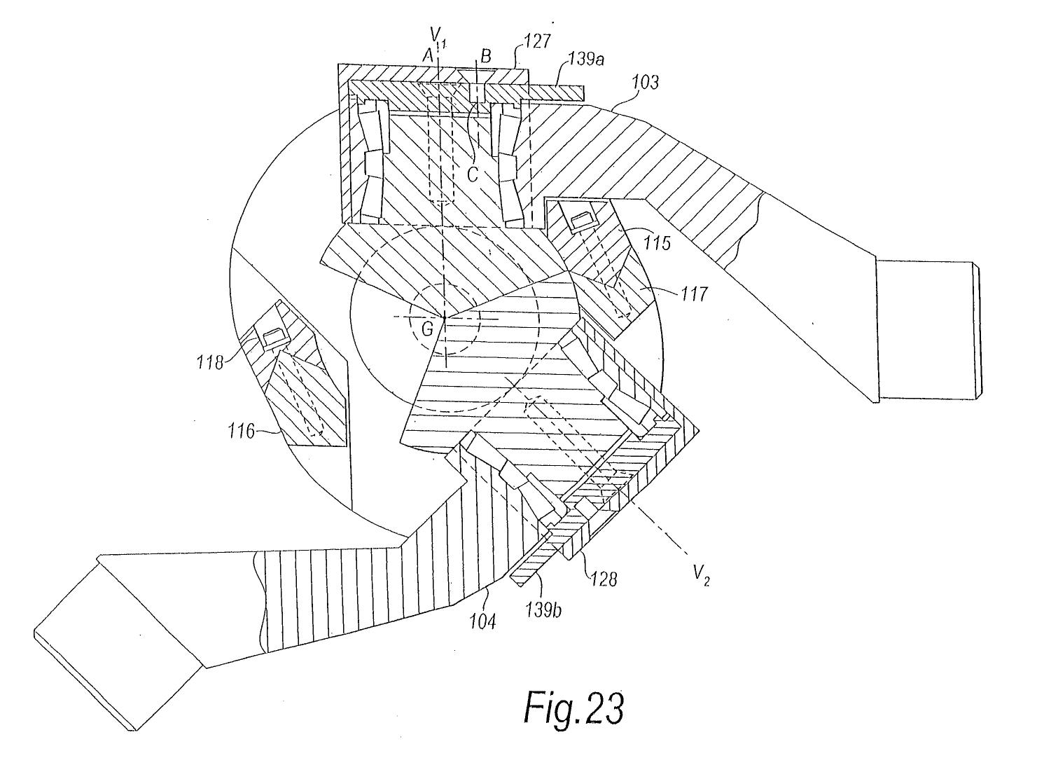

FIG. 23 is a central sectional view through FIG. 21 in direction X-X when the lower shaft has been articulated by 45° from the aligned position;

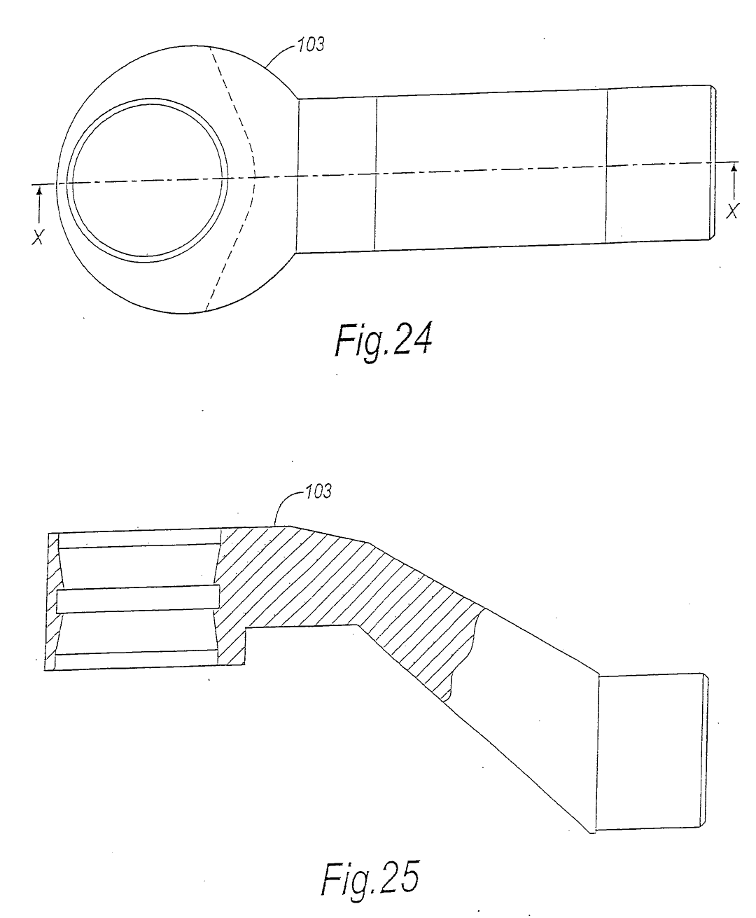

FIG. 24 is a view of just the upper shaft and claw in FIG. 21;

FIG. 25 is a central sectional view through FIG. 24 in direction X-X;

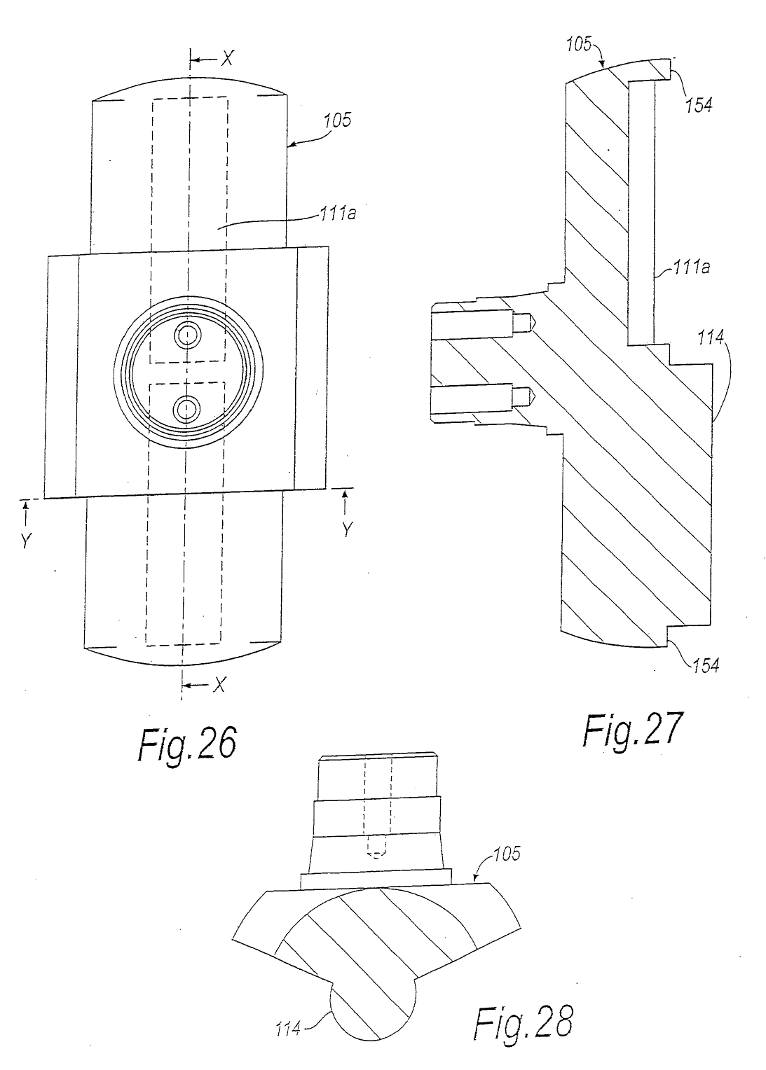

FIG. 26 is a view of just the upper cross shaft in FIG. 21;

FIG. 27 is a central sectional view through FIG. 26 in direction X-X;

FIG. 28 is a cross-sectional view in direction Y-Y in FIG. 26;

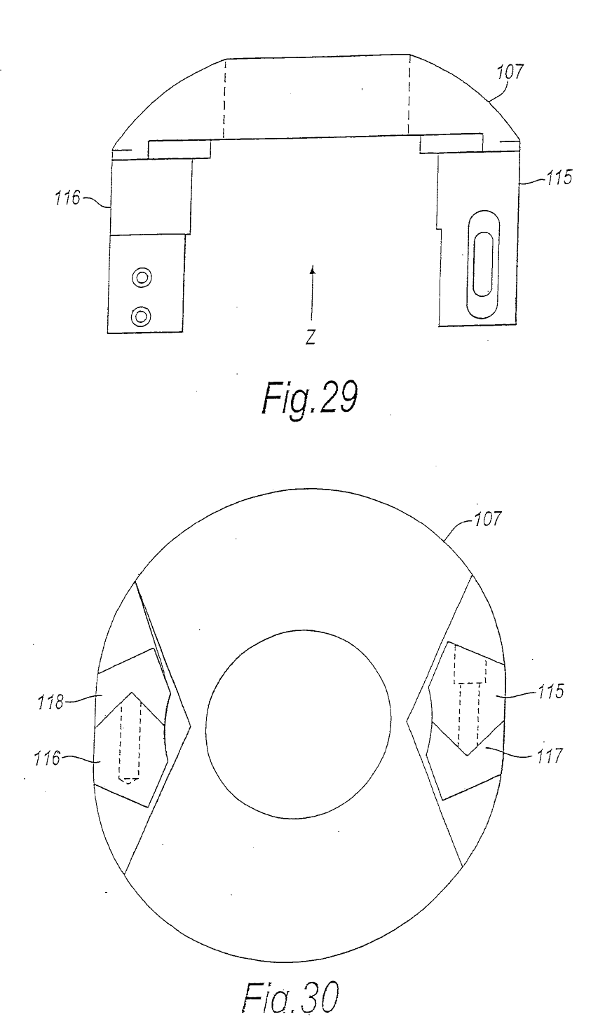

FIG. 29 is a view of just the containing ring 107 in FIG. 21;.

FIG. 30 is a view in direction Z of the containing ring in FIG. 29;

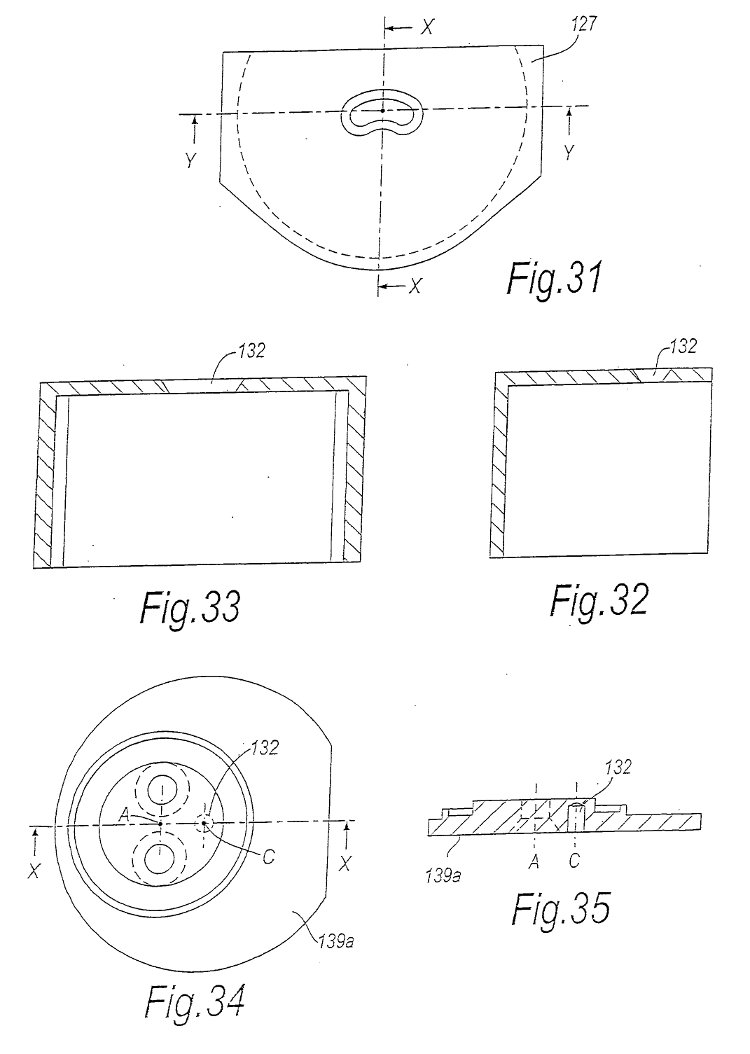

FIG. 31 is a view of just the slipper 127 in FIG. 21;

FIG. 32 is a cross-sectional view in direction X-X of FIG. 31;

FIG. 33 is a cross-sectional view in direction Y-Y of FIG. 31;

FIG. 34 is a view of the underside of preloading plate 139a in FIG. 21;

FIG. 35 is a cross-sectional view in direction X-X of FIG. 34;

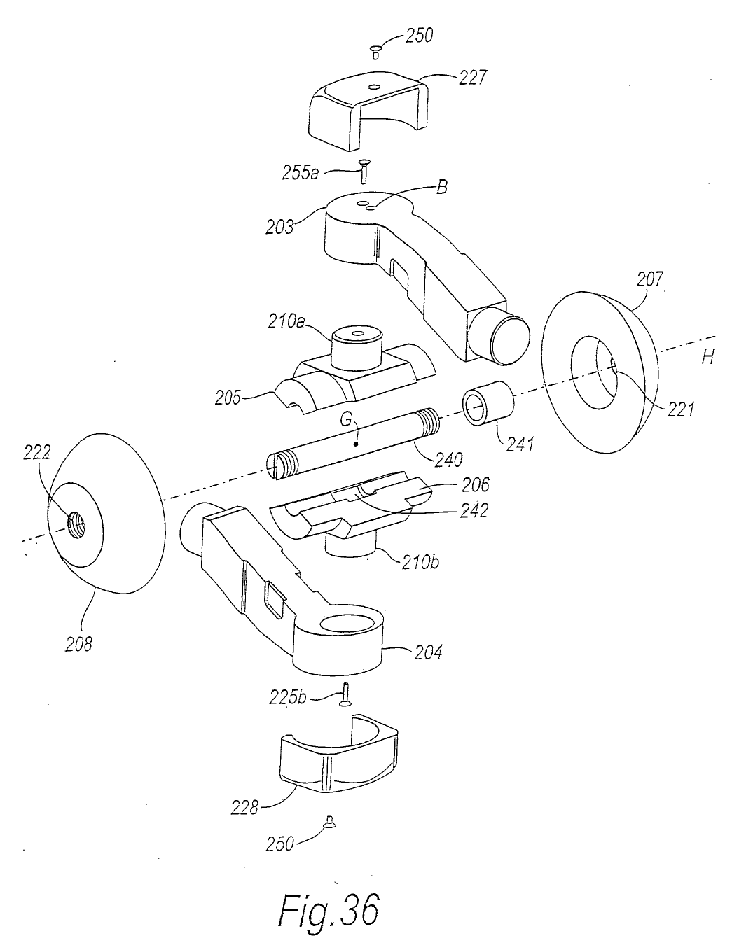

FIG. 36 is an exploded view of a third preferred embodiment of the present invention;

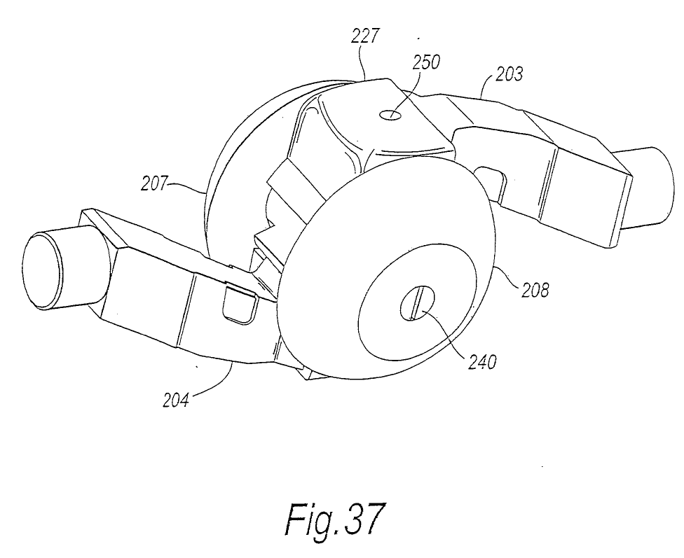

FIG. 37 is a perspective view of the joint in FIG. 36 when assembled; and,

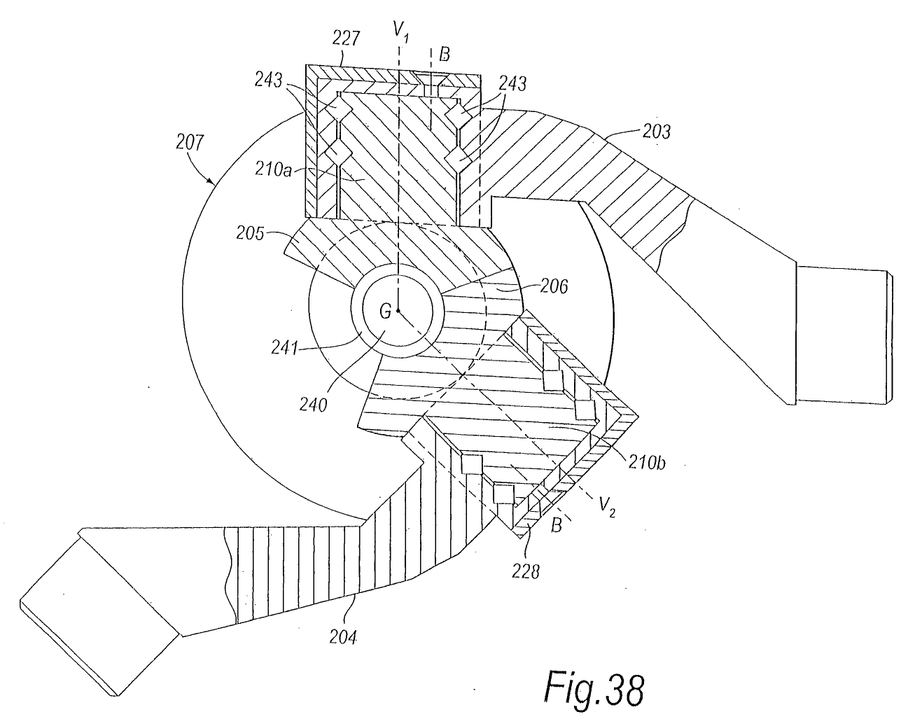

FIG. 38 is a central sectional view when the lower shaft has been articulated by 45° from the aligned position.

Reference should now be made to FIG. 1 which depicts the main elements of a first preferred embodiment of the present invention. The exploded view reveals shafts 1 and 2 each having a claw 3 and 4 located on one end. First and second hinge elements 5 and 6 respectively are rotatably mounted between the claws 3 and 4. A cage comprising containing rings 7 and 8 is provided which can reciprocate with respect to hinge elements 5 and 6 in the direction of hinge axis H and oscillate about hinge axis H.

The hinge axis H and the axis of each shaft 1,2 always intersect at the geometrical centre G of the joint whatever the articulation of the shafts may be (see FIGS. 3 and 4).

The claws 3 and 4 have an eccentric cam profile with the centre of the claw head being at point A and the centre of the cam profile being at point B (see FIG. 2). The claws 3 and 4 are mounted for rotation on the hinge elements 5 and 6 about an axis V (through point A) which passes through the geometrical centre G of the joint. It is the offset between point A and point B on each claw 3,4 which produces the eccentric movement required to reciprocate the cage with respect to hinge elements 5,6. The degree of eccentricity can be varied to accommodate any particular overall design.

In FIG. 2 the shafts 1,2 are aligned and the entire joint rotates as a solid body. Torque is transmitted from one shaft, via the claws, cage and hinge elements to the other shaft.

In FIG. 3, the shafts 1,2 have been articulated about axis V by an equal amount, i.e., through 22.5° but in opposite directions. Relative rotational movement will now also occur between each side of the joint. The eccentric cam profile of the claws 3,4 reacting against the cage (comprising containing rings 7,8) forces the cage to reciprocate on the hinge elements 5 and 6. This reciprocation can be seen by comparing FIGS. 2 and 3 where the cage has moved from its central position along hinge element 5 in the same direction as the shafts 1 and 2.

The hinge elements 5,6 are shown in detail in FIGS. 8 to 12. Each hinge element comprises a cross shaft 9a, 9b with an integral stub axle 10a, 10b. FIG. 4 is a central sectional view through the joint in FIG. 2 with shaft 2 articulated by 45°.

Referring now to FIGS. 4,5,6 and 7, the stub axles 10a, 10b sit in cylindrical recesses 38a, 38b in claws 3,4 respectively. The claws 3,4 each comprise a preloading plate 39a, 39b respectively. The preloading plates 39a, 39b are fixedly secured by way of pairs of screws 55a,55b respectively (preferably with vibration proof plastic threaded inserts) to the stub axles 10a and 10b. Claw 3 can rotate about axis V₁ with respect to the stub axle 10a and its respective preloading plate 39a on a bearing assembly comprising sets of taper roller bearings 40 and 41 located between the stub axle and the inside of the claw head. A similar arrangement is provided on the other side of the joint on claw 4 which rotates about axis V₂. It should be noted that when the articulation is only in the plane depicted in FIG. 3 the axes V₁ and V₂ coincide and become axis V as depicted in FIG. 1.

A set of taper roller bearings 40 sit between inboard inner race 43, which is a unitary construction with the stub axle 10a, and outer race 45, which is a unitary construction with the claw 3.

A further set of taper roller bearings 41 sit between outboard inner race 42, which is axially adjustable by the preloading plate 39a and screws 55a to reduce backlash, and outer race 44, which is a unitary construction with the claw 3.

FIGS. 8, 9 and 10 depict one cross shaft 9a, which is part cylindrical in profile, embracing 135° at the geometrical centre G of the joint. Cross shaft 9b is identical in form also embracing 135° at the geometrical centre of the joint, making the total embrace 270°. Each cross shaft 9a, 9b has a pair of part cylindrical grooves 11a,11b and 11c,11d respectively. Separating the grooves of each pair is a central platform 12a,12b which is Wider than the ends of the cross shaft. This is done so as to increase the cross-sectional area of the cross shafts at the inboard area where the torque arm is at its shortest and the torsional loads are at their highest. In FIG. 8, it is clear that each groove 17a and 11b has a “blind” end 54 which ensures that the centre bearings 13 and 14, which sit with an axial light press fit in the grooves, cannot move axially when the joint is articulated. Alternatively, the centre bearings could each comprise a central shoulder to prevent axial movement. Preferably, the centre bearings are manufactured in phosphor bronze to reduce friction. It should be noted that the lubricated contact area of a typical journal bearing is only about 60° so the 135° section is ample.

The cross shafts 9a,9b together with the centre bearings 13,14 form a hinge which can pivot about hinge axis H when the joint is articulated in the manner depicted in FIG. 4.

Clearly, the cross shafts 9a,9b could alternatively be manufactured as unitary constructions where each cross shaft 9a is provided with a groove on one end and an integral centre bearing on the other end thus reducing the parts count by two. In this case, the precision forging of the cross shaft would probably be in high tensile steel.

In FIG. 13, details of the containing rings 7 and 8 are visible. The containing rings 7 and 8 are each provided with projections 15,16 and 17,18 respectively. The projections 15 and 17 cooperate to form cross beam 19, and projections 16 and 18 cooperate to form cross beam 20 (see FIGS. 2 and 3). The two pairs of projections 15,17 and 16,18 are joined by a classical friction joint. The horizontal surfaces of the steps of the cross beams 19,20 are drawn together by pairs of retaining screws 25,26 whose axes are in tension. These retaining screws pass through slots 52 in one set of steps of the cross beams and are screwed into threads 53 in the other. By virtue of the slots 52 and the dimensions of the cross beam steps, it is possible using the friction joint to axially preload the containing rings 7,8 by pressing them towards each other and making preloaded contact with the slippers 27,28 (described later) and cam profiles.

There are several other known ways of joining the two halves of the cross beams, but given the need for axial adjustment and preload, the classic friction joint is considered to be the simplest.

Each containing ring has a circular bore 21,22 through which the hinge elements 5 and 6 pass. Preferably, the bores have phosphor bronze liners to reduce friction. The inner surfaces 23,24 which contact the cam profile of claws 3,4 through the slippers 27,28 are recessed to allow oscillation of the containing rings 7,8 on the surfaces of the cross shafts 9a and 9b.

The surface area of the bores of the containing rings is approximately 71.88 cm² whereas the surface area of the cage in WO 00/46522 is only 42.72 cm².

The slippers 27,28 are pivotally connected to the preloading plates 39a, 9b at point C which in FIG. 2 is aligned with the centre of the cam profile B of the claw. Slipper 27 is shown in detail in FIGS. 16,17 and 18. This slipper 27 is pivotally connected to preloading plate 39a as shown in FIGS. 2 and 4, for example. The slipper 27 comprises a cross piece 29 and legs 30 and 31. The cross piece 29 has an arcuate slot 32 for a pivot screw 50 located at point C on preloading plate 39a. The legs 30 and 31 sit between the cam profile of the claw 3 and the recessed surfaces 23 of the containing rings 7,8.

The cross beams 19,20 are always in tension when the joint is under load. There is a twisting force from the frictional loads of the slipper 27,28 on the inner surfaces 23,24 of the containing rings 7,8 but these are equal and opposite and cancel each other out.

The containing rings 7,8 must be correctly preloaded against the slippers 27,28 and in turn against the cam profiles of claws 3,4 so as to ensure an equal and opposite load through each leg of a slipper and across the opposing sides of the cam profiles. This ensures that the inboard faces of the containing rings 7,8 apply the torque both horizontally through the cross beams 19,20 and also diagonally to both pairs of cam faces and to the claw head bearings. If this preload is not applied, the bearing loads will not be shared and backlash will occur thus causing the joint to function incorrectly such that true constant velocity will not be available at all times.

The cage which comprises the containing rings performs three functions. First, it holds the two halves of the joint together in the form of a hinge. Secondly, it provides the two face cams which react through the slippers onto the cam profiles provided by the outer surfaces of the claw heads. Thirdly, it prevents any axial motion between the rotary shafts 1,2 relative to the geometrical centre G as a result of external forces imposed upon them. Similarly, the claw heads perform two functions, the first being to provide the cam profiles and the second being to contain the taper roller bearing assembly locating the stub axles to the cross shafts.

When the joint is articulated in the plane at right angles to the cross shafts 9a, 9b (FIG. 4) there is a secondary torque passing through the joint which produces a secondary force.

In accordance with the present invention, there is a centring mechanism which comprises the face cams on the cage, the slippers and the cam profiles on the claws. This centring mechanism results in the secondary force passing through the large external sliding surfaces of the joint rather than the considerably smaller internal components in the prior art arrangements. The centring mechanism compels the claws to oscillate in equal and opposite directions to each other.

By getting the cage and the claw heads to each perform two distinct and separate functions, the need is eliminated for a dedicated set of components to provide the centring mechanism, thereby significantly reducing the parts count of the joint.

The cage is fundamental to the operation of the constant velocity joint and is the one moving part which provides the centring control needed to accommodate three degrees of freedom of motion in two planes.

There are two degrees of freedom of motion in the plane perpendicular to the hinge axis H and one degree of freedom of motion in the plane perpendicular to the first plane which contains the hinge axis H. This is apparent from FIG. 4 where the cross shafts oscillate about the hinge axis H (ox and oy axes) and from FIG. 3 where the cage reciprocates on the cross shafts (oz axis).

Although the use of slippers is preferred to improve transmission of torque, these parts are not essential to the performance of the joint. Accordingly, centring control can be achieved with just one moving part which is clearly advantageous when considering wear of the joint over time.

The axial radius of arcuate slot 32 conforms to the distance A-B. i.e. the eccentricity of the cam profile. The preloading plates 39a, 39b are preloaded against the stub axles 10a,10b via inner race 42 and screws 55a,55b. The pivot screw 50 must be able to slide within arcuate slot 32 as the slipper 27 slides between the cam profile of the claw 3 and the containing ring 7 (see FIGS. 2 and 3). When preload has been applied there is clearance 51 between the surface of the preloading plates 39a,39b and the surface of the claws to allow the claws to rotate about axis V.

Each leg 30,31 has a tongue 33,34 respectively. The tongues 33,34 can slide in arcuate slots 35,36 in cross shaft 9a as the joint articulates in the manner shown in FIG. 3. The arcuate slots 35,36 prevent tilting of the slipper 27 relative to its axis. Slipper 28 is provided with an identical arrangement of tongues which slide in-arcuate slots in cross shaft 9b. The tongues are profiled to conform to the arcuate slots.

The axial length of each arcuate slot is equal to the distance travelled by the containing rings 7,8 plus the thickness of the slipper leg 30,31. The axial radius of the arcuate slot conforms to the distance A-B, i.e. the eccentricity of the cam profile (approximately 10 mm in this embodiment). The slippers should preferably be manufactured from a material having a low coefficient of friction.

FIG. 19 simply shows the washer 37 which will sit in projections 15 and 18 on the containing rings 7,8 in order to spread the tensile load under the heads of the screws 25,26 onto the surfaces of the cross beams 19,20.

FIG. 20 depicts one of the centre bearings 13 which sits in grooves 11a,11b.

Clearly, the slippers 27,28 require the containing rings 7,8 to be recessed at inner surfaces 23,24 (see FIG. 14 indicated by cross-hatching). The recesses ensure that the slippers can slide between the cam profile and the containing rings at all angles of articulation of the joint as the containing rings oscillate about hinge axis H and reciprocate along hinge axis H. The recesses 23 and 24 are symmetrical (although they need not be) in order that the containing rings 7,8 can be manufactured as identical parts.

In addition to improving sliding motion, the slippers 27,28 also improve the area of contact between those elements which transmit torque. Without the slippers there would only be “line” contact where the cam profile of claws 3,4 meets the containing rings 7,8. The slippers improve this contact since the area of contact increases by the width “w” of the legs 30,31 which sit against the recesses 23,24 (see FIG. 3, FIG. 4 and FIG. 18). In addition, the length “l” of the legs 30 and 31 must be taken into account (see FIG. 4). Typically, the width “w” will be 20 mm and the length “l” 40 mm. Therefore, the total area of contact for the two legs of each slipper will be ≈1600 mm² (the total for the 2 claws will then be 3200 mm²). This is a considerable improvement over a typical Rzeppa universal joint which has a total area of contact of about 12 mm². As a consequence, the surface pressure will be reduced by a factor of approximately 260, which will increase the life of the bearing and reduce friction.

It can also be seen that the torque in the present invention passes through a relatively large cross-sectional area of the joint when compared to the joint depicted in Figure B. In Figure B, all the torque passed through pivot pin 7b which typically has a diameter of 20 mm. Hence, since there are two shear points the cross-sectional area through which torque passes is 2π(10)²≈6.28 cm².

In contrast, the cross-sectional area in the joint according to the present invention through which torque passes is equal to the embrace of the cross shafts 9a,9b (multiplied by two since there are two shear points) multiplied by the area of the cross shafts

$$\approx 2 \times \frac{270}{360} \times π {r}^{2}$$

where r≈26 mm. Hence, the cross-sectional area for transmission of torque is 31.85 cm²which is approximately 5 times greater in the present invention.

When compared to the joint in Figure B, the torque arm has also increased considerably. In Figure B, the torque arm is half the length of the element 7a, i.e. approximately 20 mm. In the present invention, for a joint of the same overall dimensions, the torque arm is half the length of the shoulder 12a,12b, i.e. approximately 29 mm.

There is also an increase in the bearing surface area. In Figure B, this area is the circumference of the pivot pin 7b multiplied by the length, i.e. approximately (π×d×l)×cm², i.e. π×2×3≈18.85 cm². In the present invention, the bearing surface area will be

$$( π \times d \times l ) \times \frac{270}{360} \times 2$$

since there are two bearing surfaces and the embrace of the cross shafts is only 270° rather than 360°, i.e.

$$π \times 52 \times 41 \times \frac{270}{360} \times 2 \approx 100 {cm}^{2} .$$

A further advantage of the joint of the present invention is that the distance travelled by the reciprocating mass is greatly reduced when compared to the joint in FIG. 3. In the present invention, the cage will typically move by 8 mm whereas in Figure B the reciprocating mass moves approximately 20 mm. Therefore, the imbalance load (mass×distance travelled), which should be minimised, is reduced considerably in the present invention. As a consequence, outboard counterbalance weights can be reduced in mass due to the reduction in the reciprocating mass.

Finally, it should be noted that the motion of the cage over the surfaces of the cross shafts (i.e. during reciprocation along axis H and oscillation about axis H) takes the form of a continuous cylindrical ellipse thus ensuring excellent lubricant flow motion compared with ordinary reciprocating motion.

It is important when comparing the constant velocity joint according to the present invention with the prior art arrangements to distinguish between the primary torque which passes from the driving/input shaft to the driven/output shaft and the secondary force which is only produced when the input and output shafts 1,2 are articulated in the plane at right angles to the axes of the cross shafts 9a,9b (see FIG. 4). If the input and output shafts 1,2 are articulated in the plane at 90° to the plane shown in FIG. 4 (see FIG. 3), there is no secondary force. In this respect, reference should now be made to SAE Universal Joint Drive Shaft Manual AE-7 Section 3.2.8 and Appendix H of that publication.

When the joint is articulated in the plane depicted in FIG. 4, a cyclic and sinusoidal secondary force is produced as a result of the secondary torque passing through the joint which increases to a maximum at the maximum joint deflection, decreases to zero when the shafts are aligned and increases to a maximum again at the opposite maximum joint deflection.

The centring mechanism (which comprises the face cams on the cage, the slipper elements and the cam profile on the claws) is constructed such that the secondary force, produced at all angles of articulation other than zero, passes over the sliding external surfaces of the joint. In contrast, the secondary force in the prior art arrangements typically passes through the central elements such as central pin 7b in WO 00/46522 (discussed earlier).

The secondary force can be calculated using the formula F=2 sin α/₂×T where α=deflection angle. For example, when the deflection angle is 45° (as shown in FIG. 4) the secondary F will be 76% of the torque passing through the joint.

Clearly, if the joint is modified to allow a maximum deflection angle of 60° (by reducing the embrace of each cross shaft 9a,9b), the secondary force F will be 100% of the torque passing through the joint.

FIGS. 21 to 35 depict a second preferred embodiment of the present invention. It should be noted that only those elements of the first preferred embodiment which have been modified have been renumbered with reference numerals above 100×all other elements are substantially identical to those in the first preferred embodiment.

First, it will be noted that the profile of the claws 103, 104 are now in the form of a continuous arc of a circle rather than a compound arc as depicted in detail in FIG. 7 of the first preferred embodiment. This construction of the claws 103,104 means that the slippers 127,128 can be modified to embrace the claws 103,104 respectively around the cylindrical pro-ale and now take the form of a cut-away sleeve (see FIGS. 31, 32 and 33 for the specific details). Clearly, because there will be no tendency to tilt (as in the first preferred embodiment) when the claws rotate about pivot point A, the tongues 33,34 on the slippers 27,28 and cooperating slots 35,36 in the cross shafts 9a,9b can be dispensed with. However, the slippers 127,128 still need the arcuate slot 132 to allow movement of the Divot screw 150 secured at point C on the preloading plate 139a.

The cut-away sleeve configuration of the slippers 127,128 trebles the contact area between the sliding surfaces of the slippers and inward facing surfaces of the containing rings 107 and 108.

Reference should now be made to FIGS. 26 and 27 which depict a modified configuration of the centre bearings 113 and 114. The centre bearings are now longer thus improving the bearing surface area, and each cross shaft 105,106 has an integral centre bearing as is clear from FIG. 27. As in the first preferred embodiments, the “blind” ends 154 could be omitted and a central shoulder added to each centre bearing in order to prevent axial movement during articulation of the joint.

A further modification can be seen in FIGS. 23, 29 and 30 in relation to how the cross beams 119 and 120 are constructed. Cross beam 119 is formed by connecting projections 115 and 117 and cross beam 120 is formed by connecting projections 116 and 118. The projections now have cooperating “V”-shaped surfaces rather than horizontal flat surfaces as seen in FIGS. 4, 14 and 15 of the first preferred embodiment. The angle at the apex of the “V”-shape is preferably 90°. This configuration helps to align the parts correctly since tightening of the retaining screws will automatically seat the projections of each cross beam accurately.

Although the first and second preferred embodiments of the present invention each include a preloading plate 39a (FIG. 4) and 139a (FIG. 23), preloading of this kind is only required because of the nature of the taper roller bearings 40 and 41. The axially adjustable outboard inner race 42 (see FIG. 4) together with the preloading plate 39a provide the required preload to reduce backlash.

As a further modification, the taper roller bearings can be replaced by crossed roller bearings thus providing preload without the need for a separate preloading plate. Accordingly, the claws 3 and 4 can each be constructed in the form of a cylinder closed at the outer end rather than an open ended cylinder. The slipper elements 27 and 28 would then be pivoted directly to the closed end of the claws 3 and 4 respectively at point B which is the centre of the cam profile of the claw. With this arrangement the slippers 27, 28 (FIGS. 3 and 4) and the slippers 127, 128 (FIGS. 22 and 23) do not need an arcuate slot 32 and 132 to enable movement of the pivot screw 50 and 150 as the slippers do not also need to slide with respect to the surface to which they are pivoted. However, in the first preferred embodiment depicted in FIGS. 2 and 3, for example, the arcuate slots 35 and 36 would still be required to prevent tilting of the slipper 27 with respect to the cross shaft 9a.

A third preferred embodiment recognises the fact that the cross beams 19 and 20 (FIG. 2) and cross beams 119 and 120 (FIG. 22) can be replaced by a single cross beam which passes through the centre of the joint. Reference should now be made to FIGS. 36 to 38 which depict the third preferred embodiment. In this embodiment, the central cross beam also performs the function of the centre bearings in the previously described embodiments.

In FIGS. 36 to 38, It should be noted that generally only those elements which differ considerably from the first and second preferred embodiments have been renumbered with reference numerals above 200—all other elements are substantially identical to those in the first and second preferred embodiments.

As in the second embodiment, the profile of each claw 203, 204 is now in the form of a continuous arc of a circle rather than a compound arc. The slippers 227, 228 are substantially identical to those depicted in FIGS. 21, 22 and 23 embracing the claws 203 and 204. However, there are no preloading plates in the third preferred embodiment as proposed earlier. Crossed roller bearings 243 are to be used which will sit between the outer surface of stub axles 210a, 210b and the inner surface of the claws 203, 204 (see FIG. 38). The inner race of the bearing is formed on the outer surface of the stub axle and the outer race of the bearing on the inner surface of the claw. In the case of a unitary construction, the crossed roller bearings would normally be inserted through a hole in the outer race and the hole would then be plugged. Clearly, this method of construction could be employed by locating the hole or holes in the wall of the claw. It will be clear to a person skilled in this field that the crossed roller bearings 243 would provide the required preload to reduce backlash. With this arrangement, the slippers 227 and 228 will be pivoted, by way of screws 250, directly to the closed end of the claws at point B which is the centre of the cam profile of the claw. Although FIG. 36 depicts screws 225a and 225b for securing the claw onto its respective stub axle, it is envisaged that the crossed roller bearings 243 (as depicted in FIG. 38) would be able to retain the claw on its respective stub axle without using retaining screws.

It will also be clear from FIG. 36 that there is now only a single central cross beam 240 which also acts as the centre bearing on which the cross shafts 207 and 208 can pivot with respect to hinge axis H.

A ring lock 241 sits on the central cross beam 240 and can slide in the direction of the hinge axis H. Each of the cross shafts 205 and 206 has a part cylindrical centrally located recess 242 in which the ring lock 241 can sit. In this way, relative axial motion between the cross shafts 205, 206 is prevented.

The central cross beam 240 has screw threads at each end which can be screwed into threaded holes 221, 222 in the containing rings 207 and 208. The containing rings 207, 208 can, therefore, be preloaded against the slipper elements 227, 228 and the slipper elements 227, 228 can be preloaded against the cam profiles of the claws 203, 204 by simply adjusting the position of the containing rings on the screw threads away from or closer to the geometrical centre of the joint G.

It would also be possible to add nylon inserts to the screw threads on the central cross beam 240 and containing rings 207, 208 thereby reducing the likelihood of the screws loosening as a result of vibration in the joint.

A clear advantage of the present invention over the prior art arrangements is the reduction in the number of parts which is desirable from a manufacturing point of view. Moreover, the parts forming each side of the joint can be identical in form, which further reduces manufacturing costs and simplifies assembly.

In the preferred embodiments described, the joint is made in two identical halves, thereby reducing the total number of different parts to four.

The joint consists of eight main components but only four pairs, i.e., the claws, the cross shafts, the containing rings and the slippers. This means that since these could be high tensile steel precision forgings, only four different sets of dies would be required.

Where separate centre bearings are used, these are identical to each other and can be cut from standard bright drawn bar stock with no machining required.

For maximum durability and efficiency, the following surfaces of the joint should be case hardened and ground:
(a) inner faces of the containing rings
(b) outer surfaces of the claw heads
(c) bores of the containing rings, if they have no liners
(d) the surfaces of the cross shafts
(e) inner and outer races of the taper roller bearing assemblies
(f) slipper assemblies, in the event that they are not made from low-friction materials.

No dedicated plant or machinery is required for the manufacture of the joint. Only conventional precision forging, case hardening, machining and grinding plant is required, thus keeping the manufacturing plant capital costs to a minimum. This is in contrast to the extensive dedicated plant required for manufacture of the Rzeppa joint.

Finally, no selective assembly is required.

1. A constant velocity universal joint comprising two shafts, one shaft being the input and the other shaft being the output, each shaft having a claw located on one end, the claws being rotatably mounted on first and second hinge elements for rotation about an axis (V, V₁, V₂) which passes through the geometrical centre of the joint (G), and a cage which can reciprocate with respect to the hinge elements in the direction of the hinge axis (H), the cage containing the hinge elements and allowing them to oscillate relative to each other, the hinge axis (H) and the axis of each shaft intersecting at the geometrical centre (G) of the joint, characterised in that the claws have an eccentric cam profile which cooperates with the cage to produce the reciprocation of the cage with respect to the hinge elements whilst ensuring that the hinge axis (H) always lies on the bisecting angle plane between the two shaft axes.

2. A joint as claimed in claim 1, wherein the claws and cage cooperate such that the claws rotate about the axis (V, V₁, V₂) by an equal and opposite amount relative to the hinge axis (H).

3. A joint as claimed in claim 1, wherein centring control is provided by the cage which ensures that three degrees of freedom of motion in two planes are accommodated.

4. A joint as claimed in any preceding claim, wherein the cage performs two functions, the first being to hold the two hinge elements together to form the hinge and the second being to provide two face cams which react with the cam profile on the claws.

5. A joint as claimed in claim 4 wherein the cage performs a third function in that it prevents any relative axial motion between the input and output shafts relative to the geometrical centre (G).

6. A joint as claimed in any preceding claim, wherein the eccentric cam profile of each claw cooperates with the cage to produce reciprocation of the cage with respect to the hinge elements when the claws are rotated about the axis (V, V₁, V₂).

7. A joint as claimed in any preceding claim, wherein the hinge elements each comprise a cross shaft with an integral stub axle which sits in a respective claw.

8. A joint as claimed in claim 7, wherein each cross shaft is identical in form and has a part cylindrical groove and wherein a pair of centre bearings are seated between the grooves, the cross shafts thereby pivoting on the centre bearings about hinge axis (H).

9. A joint as claimed in claim 8, wherein the centre bearings prevent any relative axial motion between the cross shafts.

10. A joint as claimed in claim 7, wherein each cross shaft is identical in form having a part cylindrical recess at one end and an integral centre bearing at the other end, the cross shafts pivoting with respect to each other about the hinge axis (H).

11. A joint as claimed in any preceding claim, wherein the cage comprises two spaced containing rings fixedly connected to each other by projections which form cross beams between the containing rings and which extend parallel to the hinge axis (H).

12. A joint as claimed in claim 11, wherein the containing rings can be axially preloaded against the cam profiles to reduce backlash.

13. A joint as claimed in claim 11, wherein the motion of the containing rings over the surfaces of the cross shafts takes the form of a cylindrical ellipse thus ensuring lubricant flow motion.

14. A joint as claimed in any preceding claim, further comprising a slipper element which sits between the cooperating surfaces of a claw and the cage to increase the surface area of contact.

15. A joint as claimed in claim 14, wherein the slipper element can pivot about a point which passes through the centre of the cam profile of the claw.

16. A joint as claimed in claim 14 or claim 15, wherein a tongue is provided on each slipper element which cooperates with an arcuate slot in a cross shaft to prevent tilting of the slipper element.

17. A joint as claimed in any preceding claim, wherein each claw further comprises a preloading means to reduce backlash.

18. A joint as claimed in claim 17, as dependent on any of claims 14 to 16, wherein the preloading means is a preloading plate, to which the slipper element is pivotally connected.

19. A joint as claimed in claim 18, wherein the first and second hinge elements are fixedly secured to the preloading plate on a respective claw such that the claws can rotate about the axis (V, V₁, V₂) with respect to the hinge elements and preloading plates.

20. A joint as claimed in claim 14, wherein a centring mechanism is formed comprising the face cams on the cage, the slipper elements and the cam profile on each claw.

21. A joint as claimed in claim 20, wherein the centring mechanism enables a secondary force, produced as a result of the torque passing through the joint when articulated in the plane at right angles to the axes of the cross shafts, to pass over the sliding external surfaces of the joint.

22. A joint as claimed in any of claims 1 to 7, wherein the cage comprises two spaced containing rings fixedly connected to each other by a central cross beam which extends along and parallel to the hinge axis (H), the cross shafts pivoting with respect to each other about the central cross beam which also acts as the centre bearing.

23. A joint as claimed in claim 22, wherein each cross shaft is identical in form and has a part cylindrical centrally located recess in which a cylindrical ring lock sits, the ring lock being slidable on the central cross beam whilst locking together the cross shafts to prevent any relative axial motion between the cross shafts and being free to rotate relative to the cross shafts.

24. A joint as claimed in claim 22 or claim 23, wherein each containing ring is screw threaded onto one end of the central cross beam.

25. A joint as claimed in any of claims 22 to 24, further comprising a slipper element which sits between the cooperating surfaces of a claw and the cage to increase the surface area of contact.

26. A joint as claimed in claim 25, wherein the slipper element pivots about a point which passes through the centre of the cam profile of the claw.

27. A joint as claimed in any of claims 22 to 26, wherein each claw further comprises preloading means to reduce backlash.

28. A joint as claimed in claim 27, as dependent on claim 7, wherein the preloading means are crossed roller bearings located between the stub axle and the inside surface of the claw.

29. A joint as claimed in claim 25 or claim 26, wherein the containing rings are preloaded against the slipper elements and the slipper elements are preloaded against the cam profiles by means of the screw threads between the containing rings and the central cross beam.

30. A joint as claimed in any of claims 22 to 29, wherein the motion of the containing rings over the surfaces of the cross shafts takes the form of a cylindrical ellipse thus ensuring lubricant flow motion.

31. A joint as claimed in any of claims 22 to 30, wherein the motion of the cross shafts over the surface of the central cross beam takes the form of a cylindrical ellipse thus ensuring lubricant flow motion.

32. A joint as claimed in claim 25, wherein a centring mechanism is formed comprising the face cams on the cage, the slipper elements and the cam profile on each claw.

33. A joint as claimed in claim 32 wherein the centring mechanism enables a secondary force, produced as a result of the torque passing through the joint when articulated in a plane at right angles to the axes of the cross shafts, to pass over the sliding external surfaces of the joint.

34. A joint as shown in FIG. 36 where there are plain bearings between the stub axles 210a and 210b and the claws 203 and 204, which are prevented from tilting relative to each other by the preloading of the containing rings 207 and 208 via the cross beam 240, said preloading being equal and opposite, passing through the outer and inner walls of the slippers 227 and 228 onto the cam profiles of the claws 203 and 204.

35. A constant velocity joint substantially as herein described with reference to FIGS. 1 to 38.
